(19) United States
(12) Patent Application Publication
(10) Pub. No.: US 2016/0342320 A1
(43) Pub. Date: Nov. 24, 2016

(54) METHOD OF SHARING DISPLAY IMAGE ON MULTIPLE SCREENS AND ASSOCIATED COMMUNICATION TERMINAL

(71) Applicant: MediaTek Singapore Pte. Ltd., Singapore (SG)

(72) Inventor: Lei Huang, Wuhan City (CN)

(21) Appl. No.: 15/159,781

(22) Filed: May 19, 2016

(30) Foreign Application Priority Data
May 22, 2015 (CN) 201510266851.5

(51) Int. Cl. G06F 3/0484; G06F 3/0488; H04W 76/02; H04W 4/02

(52) U.S. Cl. CPC G06F 3/04847; H04W 4/02; G06F 3/0488; H04W 76/025; H04W 84/12

(57) ABSTRACT

A method of sharing display image on multiple screens and an associated communication terminal is provided, including: obtaining a relative location information between a first terminal and at least one second terminal; obtaining a connection information for building a connection between the first terminal and the at least one second terminal, and storing the connection information in the first terminal; confirming a second terminal located on a sliding direction on a touch screen of the first terminal according to the sliding direction and the relative location information, wherein the sliding direction is indicated by a sliding instruction detected on the touch screen; and connecting the first terminal with the second terminal located on the sliding direction to map the display image on the touch screen of the first terminal onto a screen of the confirmed second terminal located on the sliding direction.

### BACKGROUND

Performing image display on multiple screens needs complex pairing procedure, for example, Digital Living Network Alliance (DLNA) or WIFI technique is used in the procedure. Users are required to manually setup configurations on a terminal which will share the image, for example manually obtain connection information or choose a connecting terminal, but the synchronizing display of the image can only be performed on the corresponding terminal chosen by the user after the setup has been completed. If the image needs to be shared to other terminals, the user is required to manually perform the setup again, which results in an inconvenient experience.

### SUMMARY

The present invention therefore provides a method of sharing a display image on multiple screens, and an associated communication terminal, in which the sharing of display images between terminals can be implemented without complex manual operations.

According to an embodiment of the present invention, a method of sharing display images on multiple screens is disclosed, wherein the method comprises: obtaining a relative location information between a first terminal and at least one second terminal; obtaining a connection information for building a connection between the first terminal and the at least one second terminal, and storing the connection information in the first terminal; confirming a second terminal located on a sliding direction on a touch screen of the first terminal according to the sliding direction and the relative location information, wherein the sliding direction is indicated by a sliding instruction detected on the touch screen; and connecting the first terminal with the second terminal located on the sliding direction for mapping the display image on the touch screen of the first terminal onto a screen of the second terminal located on the sliding direction.

According to another embodiment of the present invention, a communication terminal is disclosed, wherein the communication terminal comprises: a processor; and a transceiver; wherein the processor is arranged to obtain a relative location information between the communication terminal and at least one second terminal, obtain a connection information for building a connection between the communication terminal and the at least one the second terminal, and store the connection information; according to a sliding direction on a touch screen of the communication terminal indicated by a sliding instruction on the touch screen and the relative location information, confirm a second terminal located on the sliding direction; and according to the connection information, control the transceiver to communicate with the second terminal located on the sliding direction for connecting the communication terminal and the second terminal located on the sliding direction to map a display image on the touch screen of the communication terminal onto a screen of the second terminal located on the sliding direction.

The method of sharing display images on multiple screens and the associated communication terminal is disclosed in the embodiments of the present invention. In the present invention, users need to maneuver a sliding action on a touch screen of the communication terminal so that a display image displayed on the communication terminal can be mapped onto screens of other terminals located on a sliding direction corresponding to the sliding action without other complex manual installation, which improves the user experience.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating a method of sharing display image on multiple screens according to an embodiment of the present invention.

FIG. 2 is a diagram illustrating a relative location between terminals according to an embodiment of the present invention.

FIG. 3A is a two-dimensional diagram illustrating four directions according to an embodiment of the present invention.

FIG. 3B is a two-dimensional diagram illustrating eight directions according to an embodiment of the present invention.

FIG. 3C is a diagram illustrating relative location information according to an embodiment of the present invention.

FIG. 3D is a diagram illustrating relative location information according to another embodiment of the present invention.

FIG. 4 is a diagram illustrating a sliding direction (or a swipe direction) on a screen according to another embodiment of the present invention.

FIG. 5 is a flowchart illustrating a method of sharing display images on multiple screens according to another embodiment of the present invention.

FIG. 6 is a flowchart illustrating a method of sharing display images on multiple screens according to another embodiment of the present invention.

FIG. 7 is a schematic diagram illustrating a communication terminal according to an embodiment of the present invention.

FIG. 8 is a schematic diagram illustrating a communication terminal according to another embodiment of the present invention.

### DETAILED DESCRIPTION

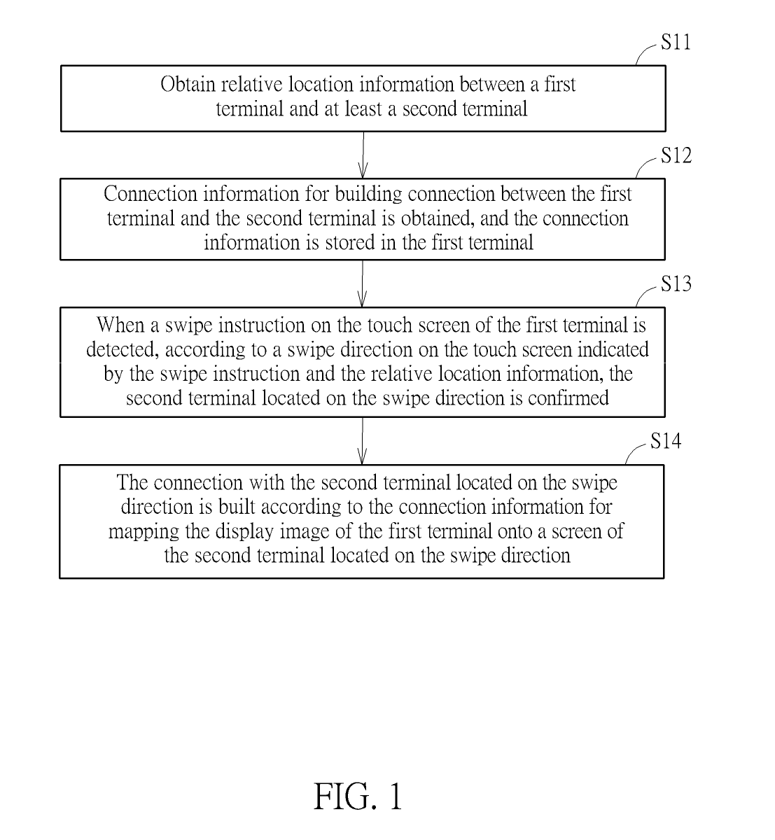

FIG. 1 is a flowchart illustrating a method of sharing display image on multiple screens according to an embodiment of the present invention. As shown in FIG. 1, the method of sharing display image on multiple screens comprises multiple steps, which are detailed in the following.

In Step S11, relative location information between a first terminal and at least one second terminal is obtained, wherein the relative location information between the first terminal and a second terminal comprises an identification of the second terminal and location information of the second terminal relative to the first terminal. The location information may indicate that the second terminal is located on the right side of the first terminal, on the left side of the first terminal, in front of or behind the first terminal.

The following first terminals are described as smart phones, and the following second terminals are described as televisions or portable playing devices. However, this is not a limitation of the present invention. The terminals can be any terminal with an image display function such as portable android devices (PADS), tablets, laptops or mp4/mp5 players.

This embodiment utilizes at least one of the Global Positioning System (GPS) technique, the G-sensor technique, the magnetic sensor technique and the WIFI technique to obtain the relative location information between the first terminal and at least one second terminal. For example, in an outdoor environment, GPS may be used to precisely obtain the location information of the first terminal and each second terminal, and thus obtain the relative location information accordingly. In an indoor environment, GPS may be used to obtain the approximate location information of the first terminal and each second terminal, and a G-sensor may be used to obtain the distance between the first terminal and each second terminal, and then a magnetic sensor is used to obtain the direction from the first terminal to each second terminal. Finally, a magnitude, an angle, a phase and a time of a WiFi signal, which is used by each terminal, are considered so that the relative location information is obtained.

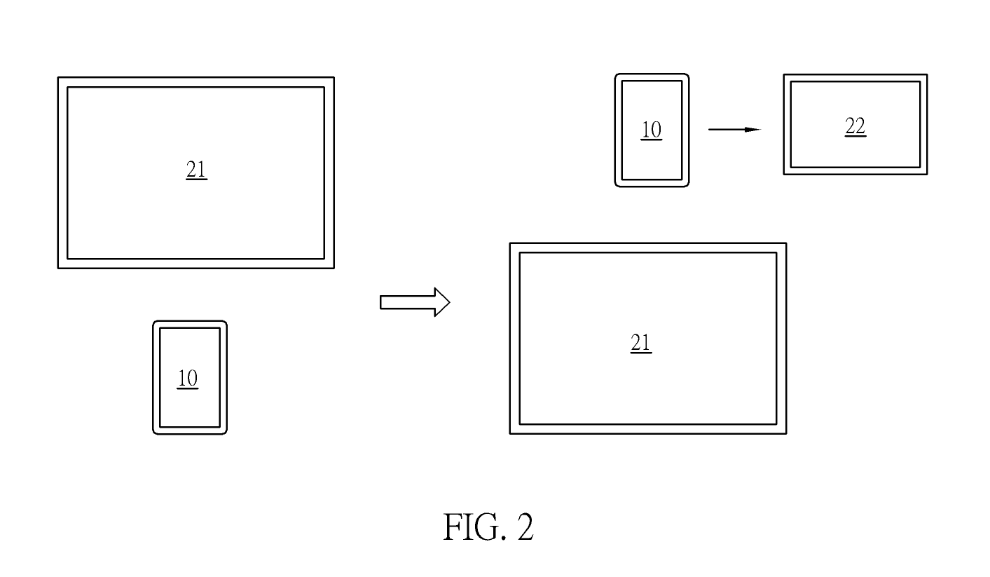

In addition, considering that the second terminal might move, the location of the second terminal relative to the first terminal might also change. As shown in FIG. 2, before the second terminal 21 moves, the second terminal 21 locates in front of the first terminal 10, and after the second terminal 21 moves, the second terminal 21 locates behind the first terminal 10. Alternatively, the first terminal moves but the second terminal stays still, accordingly, the relative location between the first terminal and the second terminal also changes.

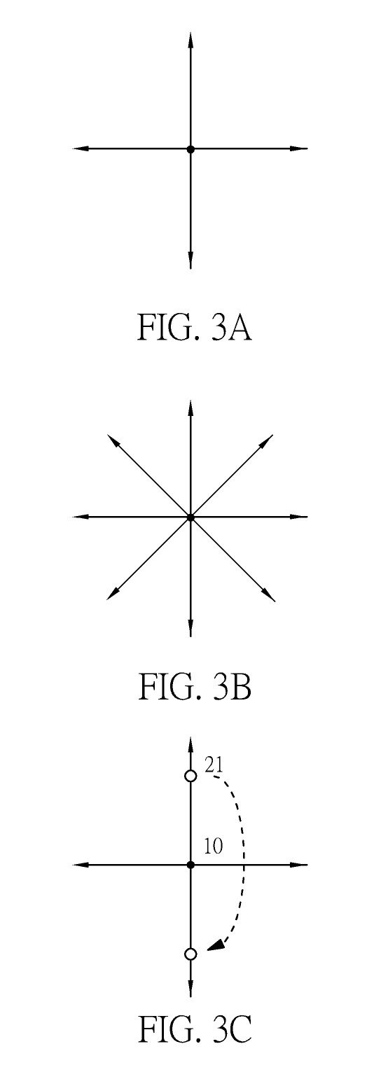

A location map is derived from the obtained relative location information, wherein the location map comprises the identification of the second terminal and the location of the second terminal relative to the first terminal. The location map can be applied not only in two dimensions such as four directions shown in FIG. 3A and eight directions shown in FIG. 3B, but also in three dimensions, wherein the centers in FIG. 3A and FIG. 3B are the location of the first terminal which will share the display image. When the location of the second terminal relative to the first terminal changes because the first terminal or the second terminal moves, the location map is also updated. As shown in FIG. 3C, the second terminal 21 moves from the front of the first terminal to the back of the first terminal.

When a new second terminal is detected in a predetermined range by the first terminal, the relative location information between the first terminal and the new second terminal is obtained, and the location of the new second terminal is added in the location map. As shown in FIG. 2, with respect to the new second terminal 22, the obtained relative location information indicates that the second terminal 22 locates on the right side of the first terminal 10. The relative location information between the stilled second terminal 21 and the first terminal 10 remains unchanged. The location map including the new second terminal is shown in FIG. 3D.

Alternatively, the user can add a new second terminal. For example, when the second terminal is not detected by the first terminal, the user can manually add the second terminal. The first terminal receives the indication from the user and adds the new second terminal to obtain the relative location information between the new second terminal and the first terminal. The location of the new second terminal is also added in the location map.

In Step S12, connection information for building connection between the first terminal and the at least one second terminal is obtained, and the connection information is stored in the first terminal.

The connection can enable data communication between the first terminal and the second terminal, and the connection may utilizes short distance wireless communication techniques such as WIFI or infrared rays, or long distance communication techniques such as mobile communication based on the 4th-Generation mobile communication standard.

If the first terminal and the second terminal are manufactured by the same manufacturer, the connection comprises an identification of the second terminal and a default password, wherein the default password is used for connecting two devices manufactured by the same manufacturer. If the first terminal and the second terminal are manufactured by different companies, the connection information comprises an identification of the second terminal and a password.

The present invention is not limited to execute steps S11 and S12 in a fixed order, and can execute step S11 before step S12, execute step S12 before step S11, or execute steps S11 and S12 at the same time.

In Step S13, when a sliding instruction on the touch screen of the first terminal is detected, a second terminal located on the sliding direction is confirmed according to a sliding direction on the touch screen indicated by the sliding instruction and the relative location information.

The sliding instruction is generated by a sliding gesture on the touch screen of the first terminal, wherein the sliding gesture is generated by the user touching the touch screen directly, or generated by the user performing a gesture above the touch screen in a predetermined range.

It is noted that with respect to whether the second terminal locates on the sliding direction, the embodiments of the present invention allow a certain bias of the sliding action performed by the user, which means when an angle between a first direction from the first terminal to the second terminal and a second direction is smaller than or equal to a predetermined threshold angle, the second terminal is confirmed to be located on the sliding direction, wherein the first direction from the first terminal to the second terminal is indicated by the relative location information between the first terminal and the second terminal, and the second direction is corresponded to the sliding gesture.

In Step S14, the connection with the second terminal located on the sliding direction is built according to the connection information for mapping the display image of the first terminal onto a screen of the second terminal located on the sliding direction.

The connection information is obtained from a plurality of connection information stored by the first terminal based on the identification of the second terminal located on the sliding direction, wherein the identification is recorded in the relative location information. Then, the connection with the second terminal located on the sliding direction is built according to the obtained connection information.

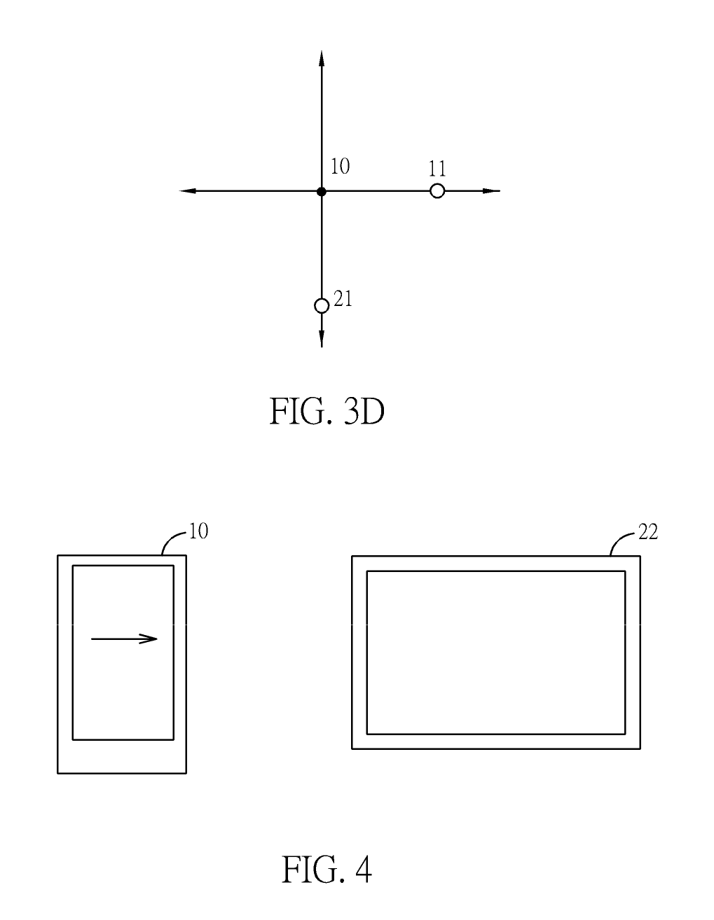

For example, when a sliding direction on the screen of the first terminal points towards the right, as with the arrow shown in FIG. 4, the display image of the first terminal 10 is mapped onto the screen of the second terminal 22 located on the sliding direction.

In this embodiment, the relative position between the first terminal and the second terminal is obtained by using an auto-positioning technology, and the connection information of the second terminal is obtained automatically. The user only needs to perform a sliding gesture on the touch screen of the first terminal, the display image of the first terminal can be mapped onto the screen of the second terminal located on the sliding direction. The procedure of sharing images on multiple screens can be implemented without any complex manual operation, which improves an experience for users.

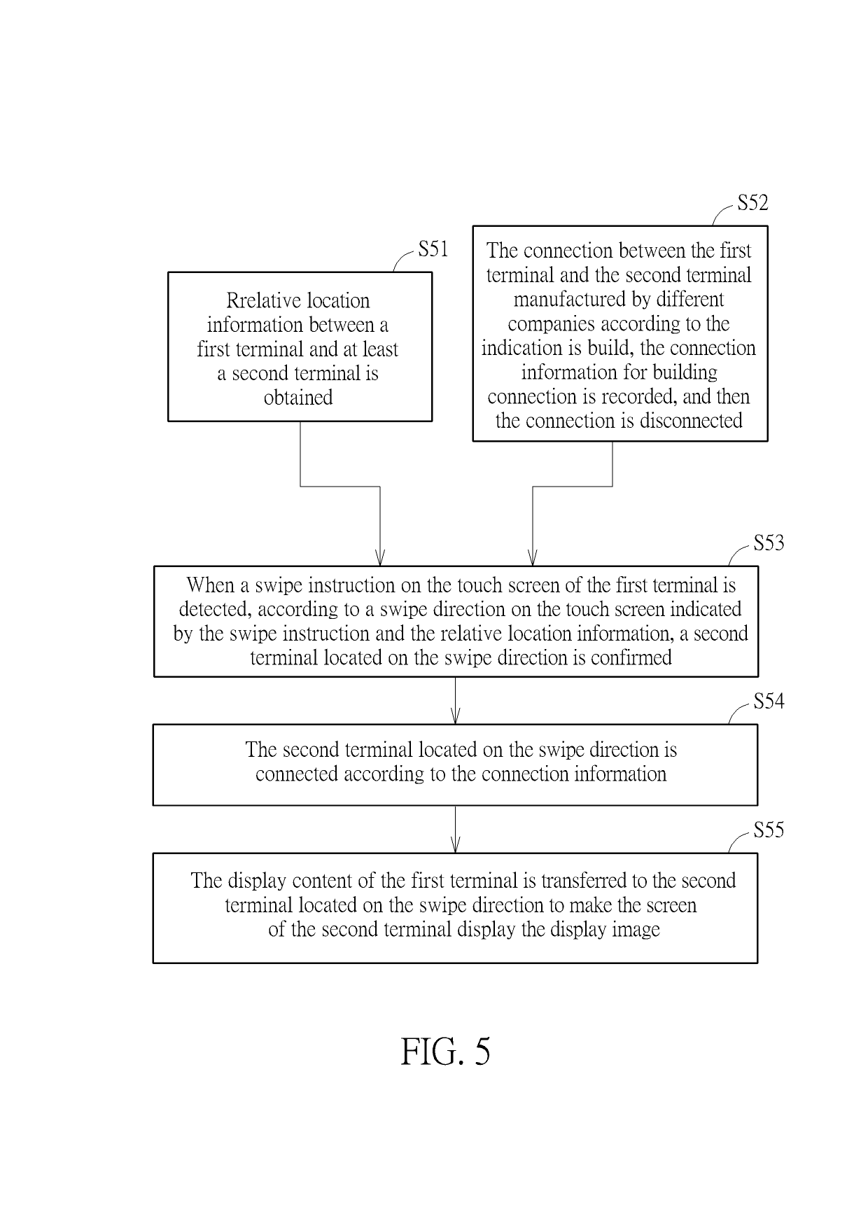

FIG. 5 is a flowchart illustrating a method of sharing display images on multiple screens according to another embodiment of the present invention. This embodiment concerns how the first terminal obtains the connection information when the first terminal and the second terminal are manufactured by different companies. As shown in FIG. 5, the flow of this embodiment comprises multiple steps, which will be detailed in the following.

In Step S51, relative location information between a first terminal and at least one second terminal is obtained.

In Step S52, when an indication for pairing with the second terminal manufactured by a different manufacturer is received, the connection between the first terminal and the second terminal is built according to the indication, and connection information for building the connection is recorded. Then the connection between the first terminal and the second terminal manufactured by different companies is disconnected, wherein the term'different manufacturer'here means a manufacturer which is different from the manufacturer which manufactures the first terminal.

The present invention is not limited to execute steps S51 and S52 in a fixed order, and can execute step S51 before step S52, execute step S52 before step S51, or execute steps S51 and S52 at the same time. The connection information comprises an identification of the second terminal and a password corresponding to the identification of the second terminal, wherein the password is arranged for connecting the first terminal and the second terminal in the following steps.

More specifically, the first terminal utilizes the connection map to store the connection information. For example, the first terminal connects with two second terminals (B1 and B2), and the connection information of both second terminals are stored correspondingly. The content of the connection map will comprise an identification of the second terminal B1, a password corresponding to the identification of the second terminal B1, an identification of the second terminal B2 and a password corresponding to the identification of the second terminal B2.

In Step S53, when a sliding instruction on the touch screen of the first terminal is detected, a second terminal located on the sliding direction is confirmed according to the sliding direction on the touch screen indicated by the sliding instruction and the relative location information.

In this step, the first terminal obtains the identification of the second terminal located on the sliding direction.

In Step S54, a connection with the second terminal located on the sliding direction is built according to the connection information.

In this step, the first terminal obtains the password corresponding to the identification of the second terminal from the connection map according to the identification of the second identification located on the sliding direction, and utilizes the password to connect with the second terminal.

In Step S55, the first terminal transfers the display image of the first terminal to the second terminal located on the sliding direction to make the screen of the second terminal display the display image.

More specifically, the first terminal can directly compress the playing display content (e.g. a video or a picture and so on), and transfer the compressed information to the second terminal via WIFI. Alternatively, consecutive images of a video can be stored into a buffer of the first terminal, and then transferred to the second terminal in sequence.

In this embodiment, the connection with the second terminal can be disconnected after the connection with the second terminal is built at the first time. After the disconnection, the preserved connection information can be used to automatically build the connection with the second terminal located on the sliding direction. Compared to the prior art, in which the connection is continuously maintained after the connection is built, the present invention uses the preserved connection information to automatically connect with the second terminal instead of maintaining the connection all the time, which saves power and avoids complex pairing procedures for rebuilding the connection.

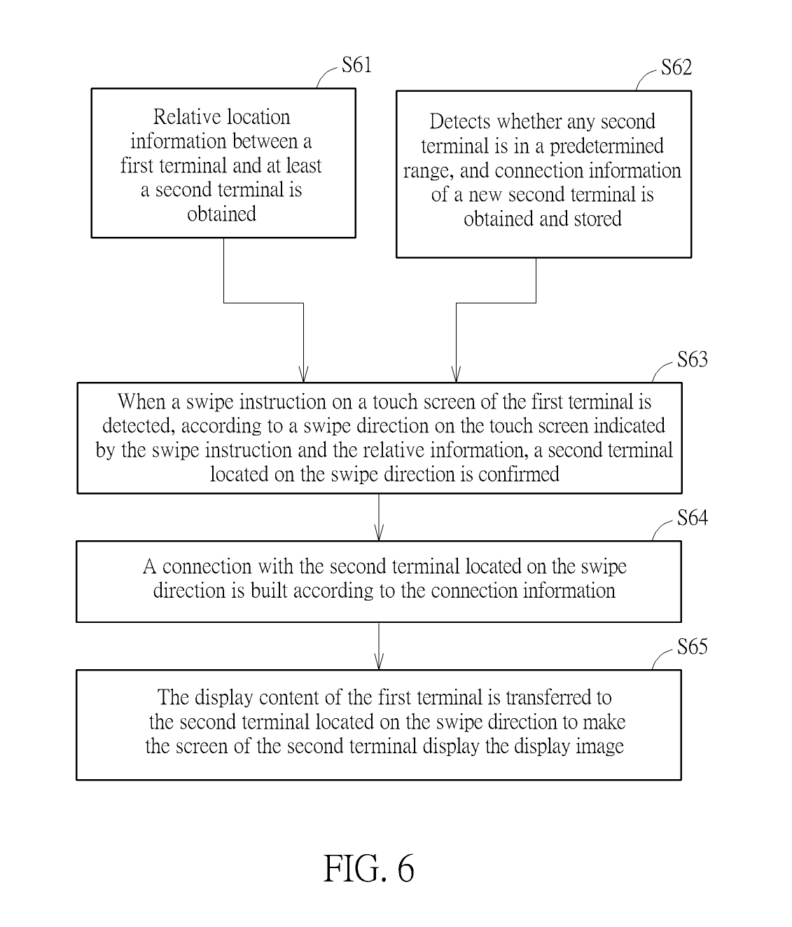

FIG. 6 is a flowchart illustrating a method of sharing display images on multiple screens according to another embodiment of the present invention. The difference between this embodiment and the embodiment of FIG. 5 is that the first terminal and the second terminal in this embodiment are manufactured by the same manufacturer. The method comprises multiple steps, which will be detailed in the following.

In Step S61, relative location information between a first terminal and at least a second terminal is obtained.

In Step S62, it is detected whether any second terminal enters in a predetermined range, and connection information of the new entered second terminal is obtained and stored.

The predetermined range in this step can be coverage of a family WIFI, and in this step, the first terminal automatically detects whether any second terminal enters the predetermined range every a time interval.

It is noted that in this step the connection information of the second terminal is obtained in the condition that the connection between the first terminal and the second terminal is disconnected.

The connection information of the second terminal in this step comprises an identification of the second terminal and a default password, wherein the default password is used for the first terminal to connect with all second terminals manufactured by the same manufacturer as the first terminal. Alternatively, the connection information of the second terminal comprises an identification of the second terminal and does not comprise the default password. More specifically, the first terminal can use a connection map for preserving the connection information. For example, the first terminal builds connection with two second terminals (B1 and B2) in this step, so the connection information of both second terminals is preserved correspondingly. In this case, the connection map comprises the information of the second terminal B1 and the information of the second terminal B2, wherein the information of the second terminal B1 comprises an identification of the second terminal B1 and a default password, and the information of the second terminal B2 comprises an identification of the second terminal B2 and the default password. In addition, it is not limited to execute steps S61 and S62 in a fixed order.

In Step S63, when a sliding instruction on a touch screen of the first terminal is detected, a second terminal located on the sliding direction is confirmed according to a sliding direction on the touch screen indicated by the sliding instruction and the relative information.

In this step, the first terminal obtains an identification of the second terminal located on the sliding direction.

In Step S64, a connection with the second terminal located on the sliding direction is built according to the connection information.

In one embodiment, the connection information comprises the identification of the second terminal and does not comprise a default password, so the first terminal searches the connection map according to the identification of the second terminal obtained in step S63. If the identification of the second terminal is comprised in the connection map but there is no corresponding password in the connection map, then the second terminal is manufactured by the same manufacturer as the first terminal, so the first terminal can build connection with the second terminal without a password. In another implementation, the connection information comprises the identification of the second terminal and the default password, and the first terminal searches the connection map according to the identification of the second terminal obtained in step S63, and obtains the default password for connecting with the second terminal. The first terminal utilizes the default password to connect with the second terminal.

In Step S65, the first terminal transfers a display content/image of the first terminal to the second terminal located on the sliding direction for the second terminal capable of displaying the display content/image on a screen of the second terminal.

This embodiment uses the preserved connection information to build the connection with the second terminal located on the sliding direction automatically. Compared to prior arts, in which the connection is maintained all the time after the connection is built, the preserved connection information of the embodiment is used to automatically connect with the second terminal instead of maintaining the connection all the time, which saves power and avoids complex pairing procedures for rebuilding the connection.

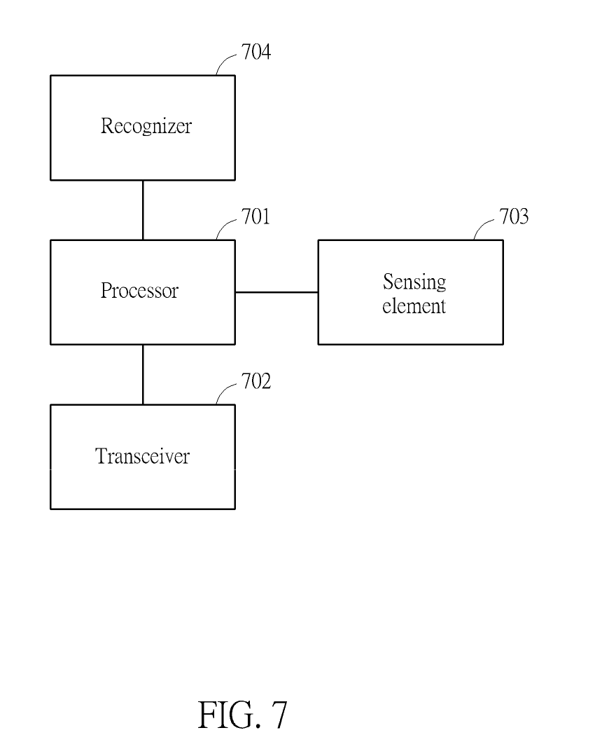

FIG. 7 is a schematic diagram illustrating a communication terminal according to an embodiment of the present invention, wherein the terminal comprises a processor 701 and a transceiver 702. The processor 701 is arranged for obtaining relative location information between the communication terminal and at least one second terminal, obtaining connection information for the communication terminal connecting with the second terminal, and storing the connection information in the communication terminal; according to a sliding direction on a touch screen of the communication terminal indicated by the sliding instruction and the relative location information, confirming a second terminal located on the sliding direction; and controlling the transceiver 702 communicate with the second terminal located on the sliding direction for building a connection between the communication terminal and the second terminal located on the sliding direction according to the connection information to map a display image displayed on the touch screen of the communication terminal onto a screen of the second terminal located on the sliding direction.

The transceiver 702 is arranged to communicate with at least one second terminal for building the connection with at least one second terminal, and transfer the display image of the communication terminal to the second terminal for mapping the display image onto the screen of the second terminal.

In one implementation, the transceiver 702 is further arranged to detect whether any second terminal enters in a predetermined range. If the first terminal and the second terminal are manufactured by the same manufacturer, the second terminal can be detected by the first terminal when entering in the predetermined range. The predetermined range can be coverage of a family WIFI, and the transceiver 702 automatically detects whether any second terminal enters in the predetermined range every a time interval. When a new entered second terminal is detected, the transceiver 702 obtains the connection information of the new entered second terminal and transfers the connection information to the processor 701 for storing the connection information, so that the processor 701 can control the transceiver 702 to communicate with the second terminal for building the connection between the communication terminal and the second terminal located on the sliding direction. The connection comprises the identification of the second terminal. Alternatively, the connection further comprises a default password.

In another implementation, the at least one second terminal comprises a second terminal manufactured by a different manufacturer, wherein the different manufacturer is different from the manufacturer which manufactures the first terminal. The processor 701 receives an indication for pairing with a second terminal manufactured by a different manufacturer; the processor 701 controls the transceiver 702 to communicate with the second terminal for building a connection between the communication terminal and the second terminal according to the indication, and records the connection information for connecting, then controls the transceiver 720 to disconnect the connection between the communication terminal and the second terminal, wherein the connection information comprises an identification of the second terminal and a password corresponding to the identification.

The communication terminal further comprises a sensing element 703 arranged to detect the location of the communication terminal and the location of the second terminal, and send the relative location information between the communication terminal and the second terminal to the processor 701 to facilitate the processor 701 to confirm the second terminal located on the sliding direction according to the relative location information and the sliding direction on the touch screen indicated by the sliding instruction on the touch screen, wherein the sensing element 703 comprises at least one of a global positioning system (GPS), a gravity sensor, a magnetic sensor and a WIFI sensing element. The detailed implementation of sensing the locations of the communication terminal and the second terminal is described in step S11. When the sensing element 703 detects that the location of the communication terminal or the location of the second terminal is changed, the sensing element 703 transfers the updated relative location information between the communication terminal and the second terminal to the processor 701.

The communication terminal further comprises a recognizer 704 arranged to detect the sliding instruction on the touch screen of the communication terminal to facilitate the processor 701 to confirm the second terminal located on the sliding direction according to the relative location information and the sliding direction on the touch screen indicated by the sliding instruction on the touch screen of the communication terminal.

The communication terminal obtains the relative location information with other communication terminals and connection information via automatic positioning in the embodiments of the present invention. In this way, the user only needs to perform a sliding gesture on the touch screen of the communication terminal so that the display image of the communication terminal will be mapped onto the screens of other terminals located on the sliding direction corresponding to the sliding gesture without complex manual installation, which improves the user experience.

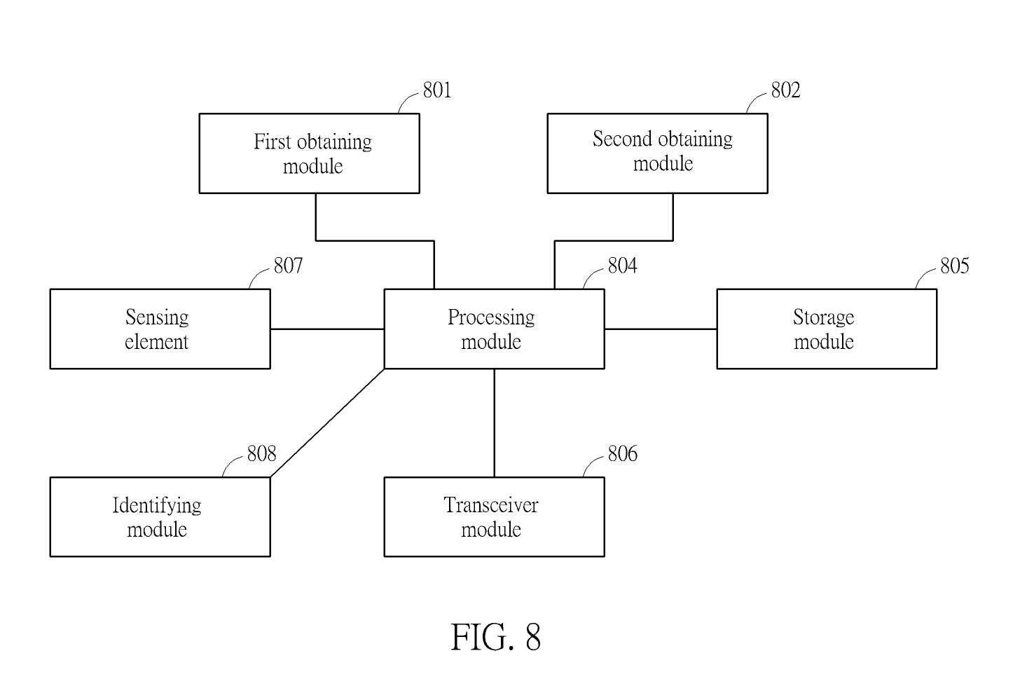

FIG. 8 is a schematic diagram illustrating a communication terminal according to another embodiment of the present invention which can share display images with other terminals. As shown in FIG. 8, the communication terminal comprises a first obtaining module 801, a processing module 804, a storage module 805, and a transceiver module 806. Selectively, the communication terminal can further comprise a second obtaining module 802, a sensing element 807 and/or identifying module 808.

The first obtaining module 801 is arranged to obtain relative location information between the communication terminal and at least one second terminal, and connection information for building connection between two terminals; the storage module 805 stores the relative location information and the connection information. The relative location information can be a location map, which can be applied in two dimensions such as four directions shown in FIG. 3A and eight directions shown in FIG. 3B, as well as in three dimensions. The processing module 804 is arranged to confirm a second terminal located on a sliding direction indicated by a sliding instruction on a touch screen of the communication terminal according to the sliding direction and the relative location information, and arranged to control the transceiver module 806 to communicate with the second terminal located on the sliding direction for building the connection between the communication terminal and the second terminal located on the sliding direction according to the connection information to make the display image on the touch screen of the communication terminal map onto a screen of the second terminal located on the sliding direction.

Transceiver module 806 is arranged to communicate with the second terminal for building the connection between the communication terminal and the second terminal located on the sliding direction, and arranged to make the display image on the touch screen of the communication terminal map onto the screen of the second terminal located on the sliding direction.

In practice, when the second terminal or the communication terminal moves, the relative location between the communication terminal and the second terminal is changed, so the location map is also updated. The communication terminal may add a new second terminal in the location map when needed, as shown in FIG. 2. Assuming the communication terminal annotated with ‘10’ is the communication terminal in this embodiment, in respect to the new added second terminal 22, the obtained relative location information indicates that the second terminal 21 locates on the right side of the communication terminal 10. At this time, the relative location information between the fixed second terminal 21 and the communication terminal 10 remains unchanged. As shown in FIG. 3D, the location map comprises the new added second terminal, wherein the new added second terminal may comprise the terminals detected automatically by the transceiver module 806, and may also comprise the terminals added manually by the user.

In an embodiment, the transceiver module 806 is further arranged to detect whether a second terminal enters in a predetermined range, wherein if the first terminal and the second terminal are manufactured by the same manufacturer, the transceiver module 806 can detect the second terminal enters in the predetermined range. The predetermined range can be coverage of family WIFI. Specifically, the transceiver module 806 automatically detects whether a second terminal is in the predetermined range every a time period. When the transceiver module 806 detects there is a second terminal in the predetermined range, the transceiver module 806 obtains a connection information of the new entered second terminal and sends it to the processing module 804. The processing module 804 stores the connection information and controls the transceiver module 806 to communicate with the second terminal for building a connection between the communication terminal and the second terminal according to the connection information when the second terminal is located on a sliding direction.

In another embodiment, for the communication terminal and the second terminal manufactured by different manufactures, the second obtaining module 802 receives an indication for pairing with the second terminal manufactured by a different manufacture. The processing module 804 controls the transceiver module 806 to communicate with the second terminal for building a connection between the communication terminal and the second terminal according to the indication and sends the connection information to the first obtaining module 801, then the processing module 804 stores the connection information and controls the transceiver module 806 to disconnect the connection between the communication terminal and the second terminal. When the second terminal is located on a sliding direction, the processing module 804 can control the transceiver module 806 to communicate with the second terminal for building a connection between the communication terminal and the second terminal.

The communication terminal can selectively further comprise the identifying module 808 arranged to detect a sliding instruction on a touch screen of the communication terminal. Therefore, according to a sliding direction on the touch screen indicated by the sliding instruction and the relative location information, the processing module 804 can confirm the second terminal located on a sliding direction.

In this embodiment, concerning whether the second terminal locates on the swipe direction, the processing module 804 allows a certain bias of the sliding action performed by the user, which means when an angle between a direction from the first terminal to the second terminal and a sliding direction is smaller than or equal to a predetermined threshold angle, the second terminal is confirmed to be located on the sliding direction, wherein the first direction from the first terminal to the second terminal is indicated by the relative location information.

The communication terminal can selectively further comprise the sensing element 807 arranged to detect the locations of the communication terminal and the second terminal, and send a relative location information between the communication terminal and the second terminal to the first obtaining module 801, Therefore, according to a sliding direction on the touch screen indicated by the sliding instruction and the relative location information, the processing module 804 can confirm the second terminal located on the sliding direction. The sensing element 807 comprises at least one of a global positioning system (GPS), a gravity sensor, a magnetic sensor and a WIFI sensing element. The detailed implementation of sensing the locations of the communication terminal and the second terminal are described in step S11. When the sensing element 807 detects the location of the communication terminal or the location of the second terminal is changed, the sensing element 807 transfers the updated relative location information between the communication terminal and the second terminal to the first obtaining module 801.

A person skilled in this art can clearly understand that the specific operation of the modules in the communication terminals by referring to corresponding operation of the flow of the abovementioned embodiments. Each module can be installed in a physical element solely or integrated. If the functions are implemented in a software way and sold as a product, the functions can be stored in a readable medium of a computer. That is, the embodiments of the present invention can be implemented as a software product which comprises a plurality of commands to make a computer device (e.g. a personal computer, a server or network device) execute all of the steps or a part of the steps described in the embodiments of the present invention.

The present invention can be implemented in a hardware way. For example, the modules shown in FIG. 8 (the first obtaining module 801, the second obtaining module 802, the processing module 804 and the storage module 805) can be integrated into a processor installed in a communication terminal and coupled to a transceiver module to share display images on multiple screens, wherein the transceiver is also installed in the communication terminal 80 and the word “couple” here means the connection between the processor and the transceiver module can be a direct electrical connection or an indirect electrical connection via other elements.

In the above embodiment, the communication terminal can obtain relative location information with other communication terminals via automatic positioning and can obtain the connection information of the other communication terminals. In this way, the user only needs to perform a sliding gesture on the touch screen of the communication terminal so that the display image of the communication terminal will be mapped onto the screens of other terminals located on the sliding direction corresponding to the sliding gesture without complex manual installation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of sharing a display image on multiple screens, comprising:
obtaining a relative location information between a first terminal and at least one second terminal;
obtaining a connection information for building a connection between the first terminal and the at least one second terminal, and storing the connection information in the first terminal;
confirming a second terminal located on a sliding direction on a touch screen of the first terminal according to the sliding direction and the relative location information, wherein the sliding direction is indicated by a sliding instruction detected on the touch screen; and
connecting the first terminal with the second terminal located on the sliding direction for mapping the display image on the touch screen of the first terminal onto a screen of the second terminal located on the sliding direction.

2. The method of claim 1, wherein the step of obtaining the relative location information between the first terminal and the at least one second terminal comprises:
using at least one of a global positioning system, an gravity sensor, a magnetic sensor and WIFI technique to obtain the relative location information between the first terminal and the at least one second terminal.

3. The method of claim 1, wherein the at least one second terminal comprises a third terminal automatically detected by the first terminal or a third terminal, which is capable of being actively added by the first terminal when the third terminal is not detected by the first terminal.

4. The method of claim 1, wherein when executing the step of obtaining the connection information for building the connection between the first terminal and the at least one second terminal, the first terminal is disconnected with the at least one the second terminal.

5. The method of claim 4, wherein the first terminal and the at least one second terminal are made by a same manufacturer.

6. The method of claim 1, wherein the step of obtaining the connection information for building the connection between the first terminal and the at least one second terminal comprises:
receiving an indication for pairing with a corresponding second terminal, building a connection between the first terminal and the corresponding second terminal according to the indication, and recording the connection information corresponding to the built connection, and disconnecting the built connection.

7. The method of claim 6, wherein the first terminal and the corresponding second terminal are made by different manufacturers.

8. The method of claim 1, wherein the step of confirming a second terminal located on the sliding direction on the touch screen of the first terminal comprises:
confirming the second terminal is located on the sliding direction if an angle between a direction from the first terminal to the second terminal and the sliding direction is smaller than or equal to a predetermined threshold angle, wherein the direction from the first terminal to the second terminal is indicated by the relative location information.

9. The method of claim 1, wherein the step of obtaining the relative location information between the first terminal and the at least one second terminal comprises:
updating the relative location information between the first terminal and one of the at least one second terminal when a location of the corresponding one second terminal relative to the first terminal changes.

10. A communication terminal, comprising:
a processor; and
a transceiver;
wherein the processor is arranged to obtain a relative location information between the communication terminal and at least one second terminal, obtain a connection information for building a connection between the communication terminal and the at least one the second terminal, and store the connection information; according to a sliding direction on a touch screen of the communication terminal indicated by a sliding instruction on the touch screen and the relative location information, confirm a second terminal located on the sliding direction; and according to the connection information, control the transceiver to communicate with the second terminal located on the sliding direction for connecting the communication terminal and the second terminal located on the sliding direction to map a display image on the touch screen of the communication terminal onto a screen of the second terminal located on the sliding direction.

11. The communication terminal of claim 10, wherein the at least one second terminal comprises a third terminal capable of being automatically detected by the communication terminal or a third terminal, which is capable of being actively added by the communication terminal when the third terminal is not detected by the communication terminal.

12. The communication terminal of claim 10, wherein the processor is further arranged to receive an indication for pairing with a corresponding second terminal, and the processor controls the transceiver to communicate with the corresponding second terminal for building the connection between the communication terminal and the corresponding second terminal according to the indication, and records the connection information corresponding to the built connection, and disconnect the built connection.

13. The communication terminal of claim 10, wherein the communication terminal and the corresponding second terminal are made by different manufacturers.

14. The communication terminal of claim 10, wherein the processor confirms the second terminal is located on the sliding direction if an angle between a direction from the communication terminal to the second terminal and the sliding direction is smaller than or equal to a predetermined threshold angle, wherein the direction from the communication terminal to the second terminal is indicated by the relative location information.

15. The communication terminal of claim 10, wherein the communication terminal further comprises:
a sensing element arranged to detect a location of the communication terminal and a location of the at least one second terminal, and transfer the relative location information between the communication terminal and the at least one second terminal to the processor.

16. The communication terminal of claim 10, wherein the processor updates the relative location information between the communication terminal and one of the at least one second terminal when a location of the corresponding one second terminal relative to the communication terminal changes.

17. The communication terminal of claim 10, further comprising:
a recognizer, wherein the recognizer is arranged to detect the sliding instruction on the touch screen of the communication terminal.
